(19) United States
(12) Patent Application Publication
(10) Pub. No.: US 2015/0116496 A1
(43) Pub. Date: Apr. 30, 2015

(54) Camera, Sensor and/or Light-Equipped Anchor

(71) Applicant: OTTARR, LLC, Port Saint Lucie, FL (US)

(72) Inventors: Derek OTTAVIANO, Port Saint Lucie, FL (US); Rachel S OTTAVIANO, Port Saint Lucie, FL (US)

(73) Assignee: OTTARR, LLC, Port Saint Lucie, FL (US)

(21) Appl. No.: 14/527,219

(22) Filed: Oct. 29, 2014

Related U.S. Application Data
(60) Provisional application No. 61/896,803, filed on Oct. 29, 2013.

(51) Int. Cl. B63B 21/26; H04N 7/18

(52) U.S. Cl. CPC B63B 21/26; H04N 7/183; B63B 2021/003
USPC 348/148

(57) ABSTRACT

A camera, sensor and/or light-equipped anchor is described. A system associated with the camera, sensor and/or light-equipped anchor provides for real-time monitoring of the anchor and for an alert system regarding the status of the anchor.

### CROSS-REFERENCE TO RELATED APPLICATIONS

This application claims the benefit of U.S. Provisional Patent Application No. 61/896,803 filed on Oct. 29, 2013, which is hereby incorporated by reference in its entirety.

### FIELD OF THE TECHNOLOGY

The technology presented herein relates to monitoring and alerting of an anchor status for a water-based vessel.

### BACKGROUND

Anchor deployment, as conventionally performed, is a trial and error process. Very often, after deploying the anchor, a person would dive down to ensure that the anchor is properly engaged. In some situations, a properly deployed anchor can move from its original location on the sea floor without the knowledge of the boat operator. In yet other situations, one may have to dive down to determine the cause of problems when retracting the anchor.

### SUMMARY

Therefore, features of at least some of the embodiments disclosed herein include providing a monitoring and/or alert system for anchor deployment/retraction and movement.

According to an embodiment, an anchor management system includes at least one of a camera and a sensing device coupled to an anchor or anchor rode of a vessel, and one or more transmitters configured to transmit data from the monitoring to a remote receiver. The at least one of a camera and a sensing device may be configured to enable monitoring of an area in proximity to a location of the anchor.

In some embodiments, one or more of an acoustic sensor, an optical sensor, or a physical movement sensor may be included in the sensing device.

In some embodiments, the anchor management system may also include a cable communicatively coupling the at least one of a camera and a sensing device to a monitoring system, and a cable management system configured to control a deployment of the cable.

The cable management system may automatically control a length of the cable in accordance with the distance from the vessel to the anchor. The cable management system may include one or more cable guides attaching the cable to the anchor rode.

In certain example embodiments, the camera coupled to the anchor or the anchor rode includes one or more light sources to illuminate a field of view of the camera. The one or more light sources may include light emitting diodes (LED).

In certain example embodiments, the camera may further include a light sensor. The LED may be automatically controlled in accordance with a reading of the light sensor.

In some example embodiments, the anchor management system may include a light source configured to illuminate such that a position and/or a status of the at least one of the camera or the sensing device is visually indicated to an operator on the vessel.

In some example embodiments, the at least one camera or sensor device is attached to the anchor or the anchor road using a quick-release mechanism.

The camera or sensor device may be attached to the anchor or the anchor road using a bendable flexible attachment that returns to substantially the original shape after each bending.

In some example embodiments, the anchor management system may include a protective housing attached via an extendable connector to the anchor or the anchor rode, and configured to float while the anchor is deployed. A signal receiver may be located in the protective housing, and configured to receive the data from the monitoring from the at least one of a camera or a sensing device. Moreover, a wireless signal transmission device may be located in the protective housing, and configured to transmit the received data to the remote receiver, where the remote receiver provides the data to a display in a monitoring system.

The extendable connector may include a cable communicatively coupling the at least one of a camera and a sensing device to one or more devices located in the protective housing. The anchor management system may further include a cable management system configured to control a deployment of the cable.

The protective housing may be further configured to house the the camera and/or the sensing device(s) before the anchor is deployed. The protective housing may further include a power source for the camera or a sensing device.

In some example embodiments, one or more reflective markers are placed on the anchor such that in the monitoring an amount of embedding of the anchor in the sea floor is determined based upon visibility of the one or more reflective markers.

In some example embodiments, the anchor management system includes generating an alert to indicate a status of the anchor based upon the monitoring.

According to yet another embodiment, an anchor management system includes at least one light coupled to an anchor or anchor rode and configured to enable monitoring of an area in proximity to a location of the anchor.

In some embodiments, a first one of the at least one lights may be configured to illuminate an area of the sea floor adjacent to the anchor and a second one of the at least one lights may be configured to operate as an indicator of a status of the anchor.

In some embodiments, first one of the at least one lights may be configured to operate as an indicator of a status of the anchor by transmitting a predetermined light pattern in accordance with a particular status of the anchor, wherein the status is determined based upon feedback from at least one sensing device.

In some embodiments, the anchor management system which includes at least one light coupled to an anchor or anchor rode may include one or more of an acoustic sensor, an optical sensor, or physical movement sensor.

These and other features, aspects and advantages of the present technology will become more apparent from the following detailed description of the present technology when taken in conjunction with the accompanying drawings.

### BRIEF DESCRIPTION OF THE DRAWINGS

FIG. 1 illustrates camera-equipped anchor, where the camera is either attached to the anchor or to a location close to the anchor, and a cable from the camera to the vessel, according to one or more embodiments.

FIG. 2 illustrates a camera-equipped anchor, in which the camera is either attached to the anchor or to a location close to the anchor, and a floating housing that includes a transmitter coupled by a communication cable to the camera, according to one or more embodiments.

FIG. 3 illustrates a sensor-equipped anchor with one or more of an acoustic, optical and physical movement sensor, according to one or more embodiments.

FIG. 4 illustrates a schematic block diagram of a system including a camera-equipped anchor, cable management system including the cable reel, and monitoring system, according to one or more embodiments.

FIG. 5 illustrates a camera cable reel, according to one or more embodiments.

FIG. 6 illustrates a camera and cabling for manual deployment after coupling at least the camera to the anchor or anchor rode, according to one or more embodiments.

FIG. 7 shows a camera in an example buoyant housing and a camera mount, according to one or more embodiments.

FIG. 8 shows another example camera and camera mount, according to one or more embodiments.

FIG. 9 shows an anchor rode attachment and pulley guide system, according to one or more embodiments.

FIG. 10 shows a wireless transmitter, according to one or more embodiments.

FIG. 11 shows a wireless video receiver and/or monitor, according to one or more embodiments.

FIGS. 12-13 illustrate views of a cable reel, according to one or more embodiments.

FIG. 14 illustrates an example connector/transmitter to connect the camera-cable to equipment on board a vessel, according to one or more embodiments.

FIGS. 15-16 illustrate views of a camera, in accordance with one or more embodiments.

FIGS. 17-22 illustrate views of a camera- and/or light-equipped anchor, according to some embodiments.

### DETAILED DESCRIPTION

Exemplary embodiments of this disclosure include an anchor monitoring and/or alert system, an anchor monitoring and/or alert method, and an anchor monitoring and/or alert apparatus. These embodiments will be described with reference to the accompanying drawings. It should be noted that the embodiments described below are illustrative only, in order to describe, for example, how the program according to this disclosure is executed, and it is not intended to limit the program or the like according to this disclosure to specific configurations described below. In order to execute the program or the like according to this disclosure, other specific configurations may be employed as appropriate according to the embodiments.

Embodiments provide camera, sensor and/or light-equipped anchors for water-based vessels. The terms vessel, boat, yacht, ship may be used herein interchangeably to refer to any vehicle or platform operable on water and which is configured for the use of an anchor. One or more of a camera, acoustical sensor, physical movement sensor, optical sensor or light source may be attached directly or indirectly to the anchor. The camera, sensors and/or light(s) enable the monitoring of, for example, the anchor when it is being deployed, retracted and/or when it has already been deployed in mooring the boat. A camera may, for example, provide for monitoring the location at which the anchor has engaged (e.g., dug in) on the sea floor and the surrounding area. The camera may include capabilities for acquiring still photos and/or video. One or more of the other sensors and/or light may provide for alerting an operator of the boat when, for example, an undesired movement of the anchor is detected.

Camera-Equipped Anchor with Data Cable from Camera to Boat

An embodiment provides a camera-equipped anchor for a boat, with a cable extending from the camera to the boat. The embodiment includes a camera, camera cable, cable management system and a video transmitter, and is configured to be used to monitor a boat's anchor and/or the area around the anchor.

The camera is attached to or near the anchor (e.g., attached to the anchor or to the anchor rode) with a mounting system and is affixed such that the anchor and/or an area immediately adjacent to the anchor is in the field of view of the camera. In some embodiments the anchor and/or an area immediately adjacent to the anchor is in the field of view of the camera substantially at all times. In some other embodiments, the camera field of view can be controlled from a control system located in the boat. The cable management system allows the camera to move with the anchor during anchor deployment and retraction (and also during anchor movement at other times) and to allow the anchor and surrounding area to be monitored in real time during deployment and retraction as well as when the anchor is set. One end of the cable is connected to the camera while the other end is routed back to the boat. The camera cable may be configured to carry power to the camera and to also deliver the video signal from the camera back to the boat. In another embodiment, the camera may receive power via, for example, a battery co-located with the camera. The video signal can be connected via the camera cable, or wirelessly, into a receiver and monitor for viewing and/or recording. According to another embodiment the video signal can be re-transmitted from the receiver on the boat to be viewed at one or more remote locations.

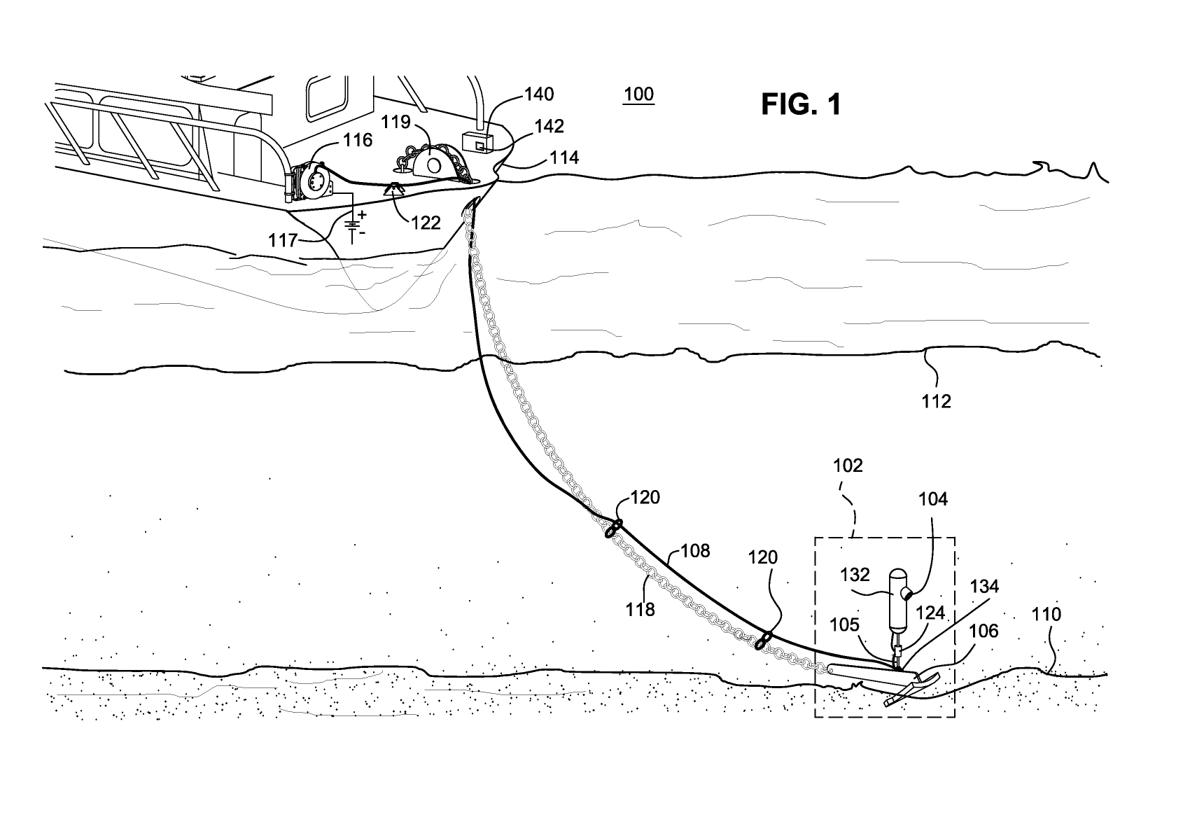

FIG. 1 illustrates an environment 100 in which a camera-equipped anchor 102 is used, according to an embodiment. A camera 104 may be attached to a location on or near the anchor 106. Camera 104 may be a waterproof camera that is, for example, capable of under water depths over 100 feet (or, for example, the depth of a particular type of body of water in which the boat is anchored) for sustained periods of time (e.g., a predetermined number of hours or days). The camera 104 preferably includes one or more bright lights (e.g., light emitting diodes or “LED”) to illuminate an area in the field of view at night and/or may include low-light sensitivity enhancement features (e.g., Sony Ex-View HAD CCD). The camera may include LEDs facing towards the anchor 106 (e.g. towards the sea floor 110), towards the water surface 112, or in both directions, in order to provide illumination in low light conditions and visibility of anchor position thus improving the clarity of the video image. The camera 104 may include one or more of still photo (with or without flash) and/or video capabilities.

A camera cable 108 is configured to communicatively connect camera 104 to receiving, control, monitoring and/or playback equipment located on the boat. Cable 108 may comprise a rugged cable with one or more conductors provided inside an insulated and/or armored outer jacket. The material with which cable 108 is made may include abrasion resistant materials such as, for example, Kevlar, polyurethane, polyvinylchloride and polypropylene. For example, the outer jacket of the cable 108 may be formed using Kevlar for enhanced durability.

The cable 108 may communicatively couple camera 104 to the boat in one of several ways. According to one embodiment, the cable 108 may run from inside the camera 104 (e.g. attachment point of the cable 108 to the camera 104 is within the camera 104) back to the boat 114. This provides a streamlined cable approach whereby the camera cable 108 does not have any weak areas (e.g., weaker at the connection point relative to other portions of the cable), protruding connectors or connection points that may allow water ingress to the connection point or to the camera in a manner that can negatively affect the operation and functioning of the camera. This embodiment enables an operator to manually release the camera cable and eliminate the cost associated with additional cable management systems. Using this approach may eliminate components (e.g. a cable reel, mounts and cable guidance systems) and associated costs designed to organize/manage the cable during deployment and retraction of the camera-equipped anchor. This approach can be particularly advantageous on small boats that do not have electronic windlass systems and do not require passive deployment/retraction of the camera with the anchor (e.g., the camera can be attached to the anchor and manually deployed/retracted with the anchor).

According to another embodiment, cable 108 may run from inside the camera 104 back to the boat, and into a cable reel 116. The cable reel 116 enables the passivity of camera/cable deployment and retraction. An operator does not have to manually manage the cable since the cable reel can automatically wind and/or unwind the camera cable according to the distance from the boat to the anchor (e.g. as the boat moves away from the anchor the cable reel unwinds and as the boat moves closer to the anchor the cable reel rewinds the cable on the reel). The cable reel 116 can be manual (e.g., requiring an operator to crank/spin the reel to wind the cable), spring loaded (e.g., the cable reel will always retract unless enough tension is applied to unwind the cable) or powered (e.g., electrically powered to wind and unwind when needed).

According to yet another embodiment, cable 108 may be connected to camera 104 with a waterproof connector at the back of the camera or within a very close distance (e.g. 1-12 inches) of the back of the camera, and the cable may be routed from the waterproof connector back to the boat 114 or cable reel 116 (or back to the boat and into the cable reel). The waterproof connector allows efficient and rapid removal/replacement of the camera from the cable in cases of repair, replacement or upgrade to another camera model. FIG. 1 illustrates a waterproof connector 124, such as that discussed above, located close to the camera 104. In some embodiments, the waterproof connector 124 is contained inside of a hollow armature connecting the camera to the mount. The hollow armature may provide additional protection to the waterproof connector.

According to still another embodiment, the camera cable (e.g., such as cable 108) operates as the only, or as the primary anchor rode, for the boat, and also allows transmission of signals from/to the camera-enabled anchor (e.g., the camera cable is inside of a rope (or chain) that is used as the boat's primary anchor rode). In this embodiment the anchor (and camera) may be attached at one end of the camera cable, and equipment on the boat would be attached to the other end. The camera cable may be deployed and retracted manually or by the use of a powered system such as, for example, a windlass (e.g., FIG. 1 illustrates an example windlass 119 used for deploying the anchor rode). This embodiment has the added advantages of enhanced durability of the camera cable, preventing the potential of tangling of the camera cable with the anchor rode (e.g., such as that can occur when the camera cable 108 and anchor rode 118 are routed separately from the camera-enabled anchor 102 to the boat 114 and/or cable reel 116, as shown in FIG. 1) and reducing or eliminating the need for a separate cable management system by using the boat's existing anchor rode management system (e.g., such as a system including windlass 119).

A camera cable management system may include a deployment/retraction reel 116, a camera cable to anchor rode attachment system which includes one or more camera cable to anchor rode attachments 120, and a camera cable routing system 122. The camera cable to anchor rode attachment system allows the camera cable 108 to stay attached to the rode 118 to prevent the camera cable from dragging and/or getting snagged on objects that, for example, are on the ocean floor. The camera cable to anchor rode attachment system may keep the cable 108 above the rode due to the continuous tension on the camera cable provided by the cable reel 116 (and/or cable management system). The anchor rode attachment system may also enclose the cable with the rode (e.g., into a protective sheath that encloses the cable and the rode such that they are routed together during deployment and retraction). The cable routing system 122 allows the cable 108 to be guided smoothly into and out of the cable reel 116, boat compartments and other objects that may be present on the deck of the boat, thereby preventing any undesirable friction or abrasion to the camera cable 108, for example, when the boat is at extreme angles relative to the anchor 106.

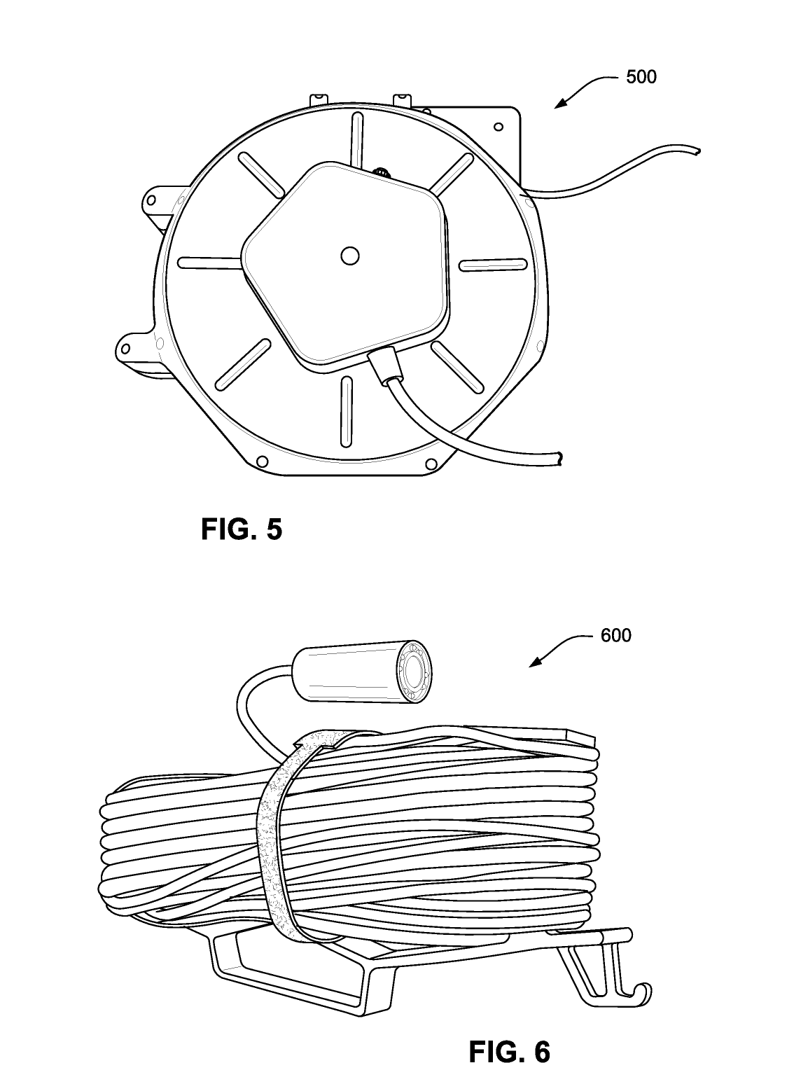

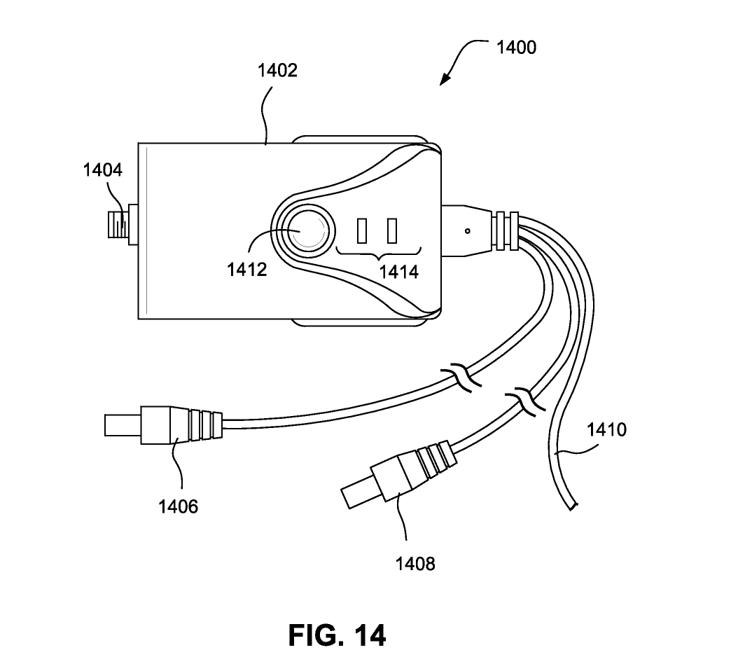

Cable reel 116 provides for deployment and/or retraction of camera cable 108, and may be mounted or otherwise located on the boat. Cable reel 116 includes a mechanism arranged to wind the camera cable on and off the reel as the anchor is deployed and retracted. The retraction may be based upon, for example, any of spring loaded retraction, manual retraction, or motorized retraction, with or without a lockout feature to hold the reel from spinning. The cable reel can be configured to pass through power, video and audio connections via one or more cables 117. An example camera reel 116 is shown in FIG. 5. FIG. 14 shows an example connector/transmitter to connect the camera cable managed by a cable reel (e.g., cable reel 116) to onboard equipment such as a video receiver and/or monitor and power sources.

One or more camera cable to anchor rode attachments 120 are used for attaching camera cable 108 to the anchor rode 118. The attaching may be accomplished using, for example, one of several techniques. According to a first attachment technique, camera cable 108 is attached to the rode 118 with spring loaded clips (e.g., clips that are of a carabiner style that allow attachment to a chain link or a clamp style that squeezes a rope rode).

A second technique is to attach camera cable 108 to the rode 118 with spring loaded clips that each has a pulley attached to a clip, and the camera cable is arranged to run through the pulley (e.g., the clip is used primarily to attach the pulley to the chain quickly).

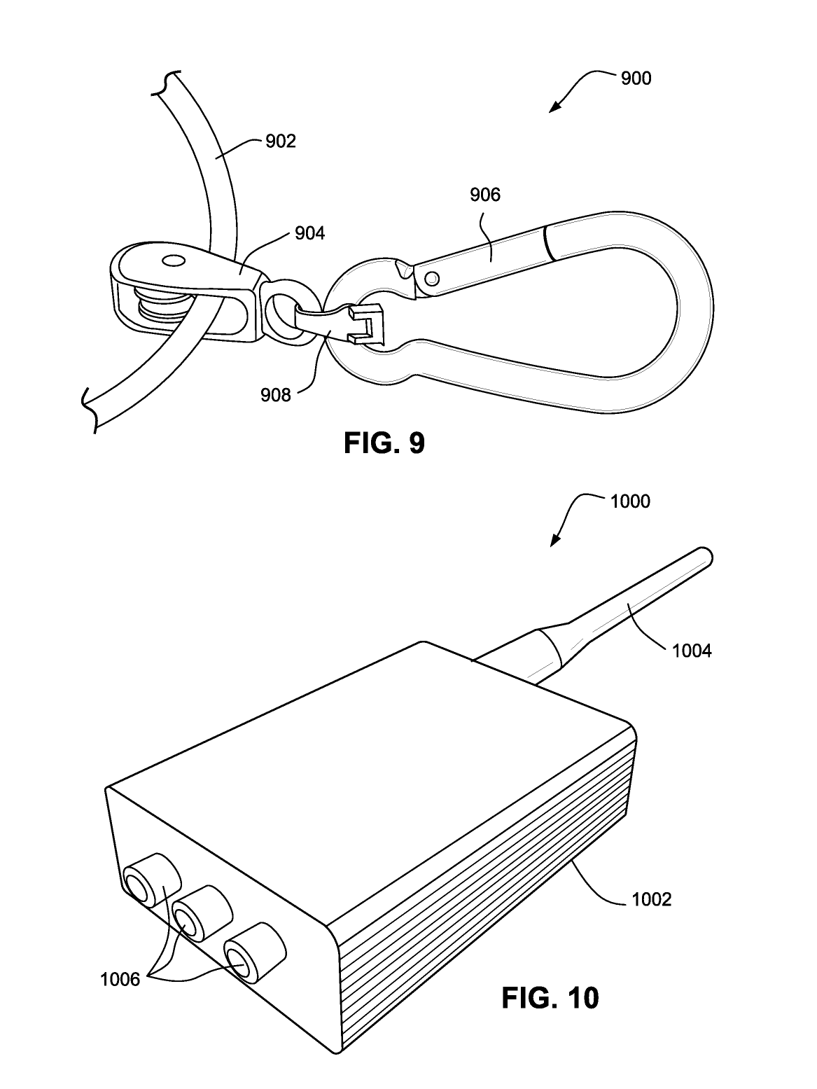

A third technique is to attach camera cable 108 to anchor rode 118 with spring loaded clips (e.g. carabiner style) that have a low friction circular loop (or similar shape) guide attached to the end of the clip. This enables the camera cable 108 to slide through the guide. An example, anchor rode attachment and pulley guide is shown in FIG. 9.

A fourth technique is to attach camera cable 108 to the rode 118 with a friction fit push through plug that is quickly pushed through a chain link. The plug may have a pulley attached to it so that the camera cable can be run through the pulley. The plug may be pushed through a chain link to attach, and may be pulled out to detach.

A fifth technique is to attach camera cable 108 to anchor rode 118 with a flexible sleeve (or coil) that is affixed circumferentially around the anchor rode. Upon deployment of the anchor (with the flexible sleeve) the sleeve is elongated/stretched such that it covers the rode 118. The camera cable 108 is either part of or routed inside the sleeve.

A sixth technique is to attach camera cable 108 to the anchor rode 118 with permanent or semi-permanent fixation. This technique may be used in a system without a cable deployment/retraction reel, and the camera cable may be run substantially together with the rode.

A camera cable routing system 122 is configured to guide the camera cable from the output of the cable reel 116 in order to adjust the trajectory of the cable in accordance with the anchor rode 118 and boat design. The camera cable routing system 122 may include one or more low friction conduits and/or mounted pulleys that can be adjusted, for example, during installation, to guide the path of the cable 108 along a desired path (e.g., from the cable reel output to the outside of the boat).

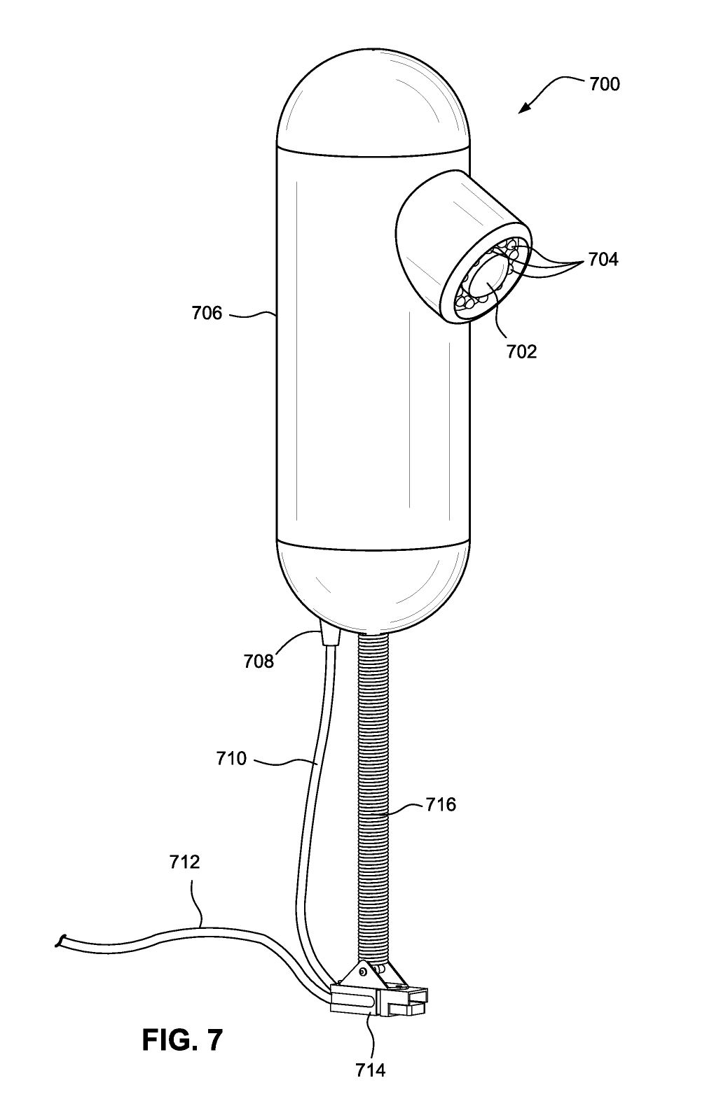

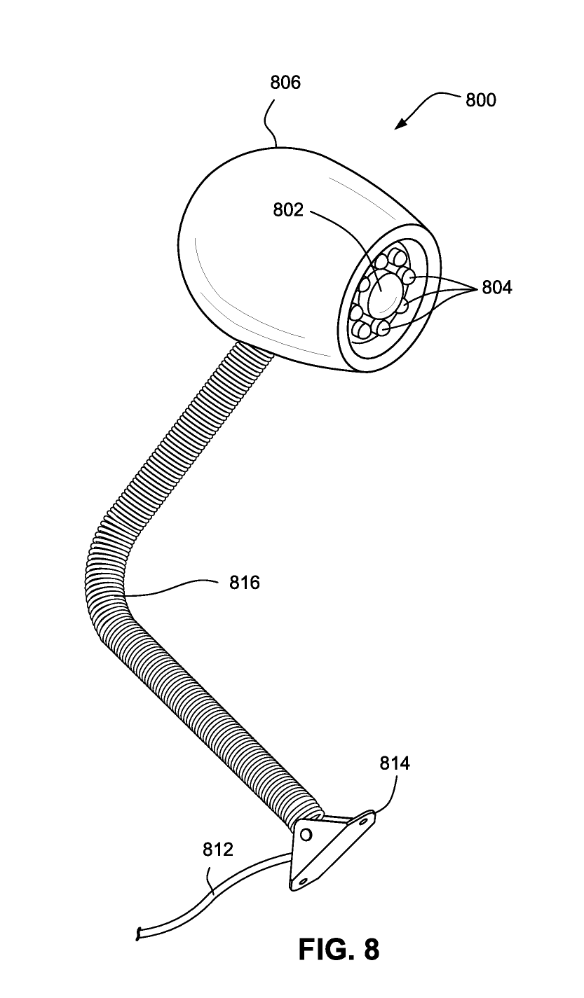

A camera housing and mount system is configured to provide a protective cover and attachment apparatus for the camera 104. The camera housing and mount system may include a protective camera housing 132 and a camera mount 134. An example camera housing and mount is shown in FIG. 7. FIG. 8 illustrates the flexibility of an example camera mount and/or armature. An example camera, with attached cable, before being wound on a reel is shown in FIG. 6.

Camera housing 132 includes the protective housing within which the camera 104 is located. The housing may be configured to provide cable strain relief, may enable attachment to a mounting system, and may be molded or machined during manufacturing to allow correct alignment of the camera (e.g. keyed so that the camera will have proper orientation such that its field of view would include the anchor and/or immediate area surrounding the anchor).

Camera housing 132 may include a sealed, rigid, molded plastic housing or a rigid foam (e.g. expanded polystyrene) housing to protect the camera 104. The protective camera housing may be buoyant, non-buoyant or neutrally buoyant. A buoyant protective housing enables the camera to automatically float above the sea floor/anchor without the use of a mechanical or electrical means of actuation (e.g. torsion spring or motor). A neutral or non-buoyant protective housing may provide for a reduced camera housing size, increased material density for durability, and linear buoyancy characteristics as depth changes.

Camera mount 134 may be attached to armature 105 which is coupled at one end to the camera housing 132 and to the mount 134 at the other end. Mount 134 attaches the camera housing 132 (e.g., via armature 105) to the anchor 106 (or anchor rode—chain or rope). The mount 134 may be configured for a quick disconnection (e.g., electromagnetic disconnect, magnetic disconnect, solenoid actuated disconnect, or detent disconnect when a tension threshold is reached or manual release button/lever is actuated) from the anchor 106 or rode. Quick disconnect allows the boat operator to retrieve the camera, sensor and/or light without retrieving the anchor. This may be useful in situations where the boat will be anchored for extended periods of time and the operator desires to set the anchor properly but retrieve the camera, sensor and/or light attached to the anchor prior to biological growth or mechanical fowling and/or tangling of the cable. Another advantage is that the camera system will release and/or separate from the anchor to prevent cable breakage in the event the cable gets caught on some object (e.g. coral head, sea floor, boat rudder etc.). According to an embodiments, one or more neodymium magnets are encased in the mount with the mount acting as a strain relief for the cable, such that all cable force is directed to the mount. When the cable is pulled (e.g., by the operator or when cable is caught on some object), then the magnetic mount slides off the anchor once a threshold tension is reached. The system (e.g., camera, sensor and/or light with armature) can then be retrieved by the boat operator without the anchor.

The armature 105, which connects the mount to the protective camera housing may be rigid or semi rigid and capable of being subject to repeated bending/deflection, always returning to its original shape or substantially its original shape. The mount 134, the armature 105 and/or the protective housing 132 may be configured to allow for adjustment of the camera viewing angle. The mount may include a torsion spring connecting the mount to the armature that the camera is mounted to, in order to assist or set the angle of the armature relative to the mount/anchor. In some embodiments the one more lights may be located on the mount or armature, in addition to, or instead of, the lights included in the camera.

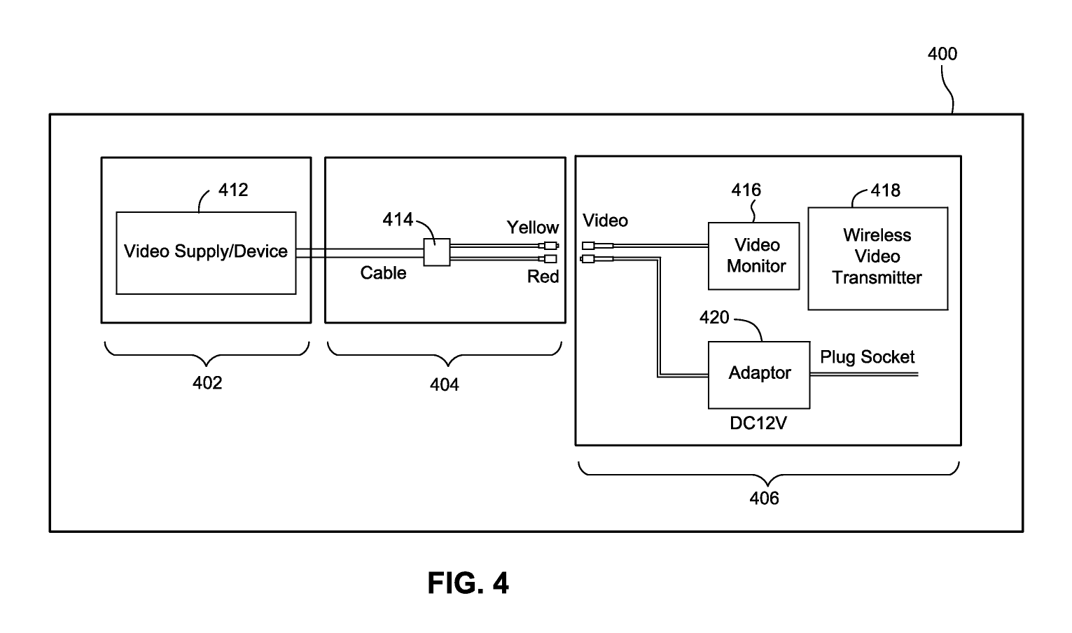

According to another embodiment, camera mount 134 is attached to the anchor rode 118 with a “car” (not shown in FIG. 1) that houses the camera and is capable of moving itself long the rode in either direction. The “car” may be motorized and capable of travelling the rode 118 in either direction in accordance with commands received from a control system 140 on the boat (or on some other remote location/device) to move, for example, in the direction of the anchor 106 or in the direction of the boat 114. The camera cable reel 116 may be configured to wind and unwind as needed as the car is moved up or down the anchor rode. The camera cable reel will also wind and unwind if the car is not moved but the anchor is deployed or retracted since the car is attached to the anchor rode. An example portion of the control system is shown in FIG. 4.

A camera cable strain relief (e.g. integrated into mount 134 in FIG. 1) provides a point of mounting/retention of camera cable to/within mount 134. In some embodiments, the strain relief may be part of or connect to the quick release camera mount 134.

One or more video and/or audio transmitting, receiving and monitoring devices 142 may be provided in the control system 140. According to an embodiment, the video and/or audio may be transmitted over cable (e.g., direct wire connection from reel, or camera cable (for embodiments without a reel), to a monitor, smartphone, tablet, or computer). According to another embodiment, the video and/or audio from the camera and/or other sensor may be transmitted wirelessly. The wireless transmitter may be built into the reel, attached to the outside of the reel, tethered to reel and mounted to something besides the reel, or may be configured to enable the camera cable to be plugged (e.g. for embodiments without a reel). In some embodiments, the video and/or audio data transmitter may be positioned underwater (e.g., nearby or attached to the anchor). An example wireless transmitter is shown in FIG. 10.

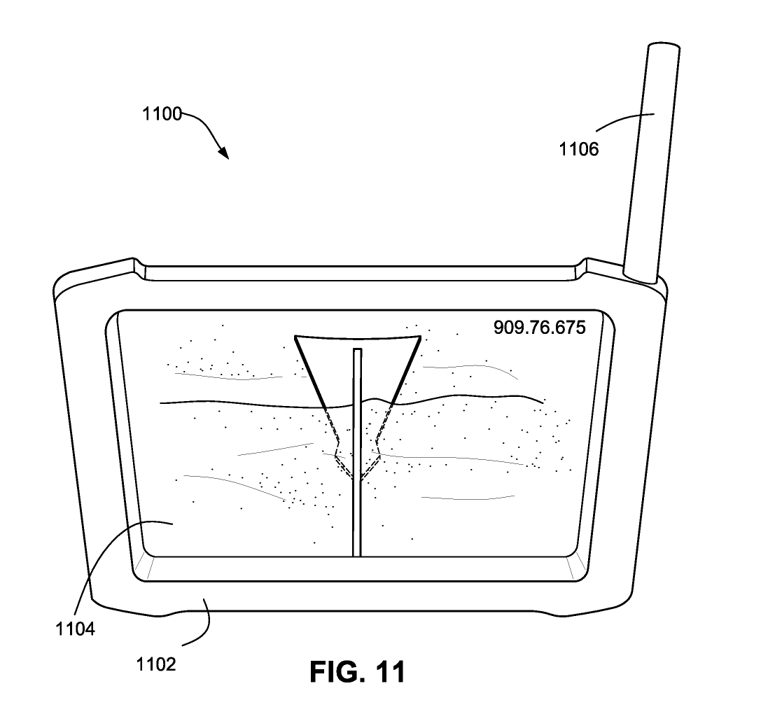

The wireless signal may be received and monitored by a device of the control system 140 on the boat in one of many ways. In an embodiment, the received wireless signal may be provided to a fixed or handheld receiver that has a built in monitor (display). In another embodiment, the received wireless signal is transmitted into a receiver that can be plugged into a monitor (e.g. separate display, computer, smartphone, or tablet). An example monitor is shown in FIG. 11.

In yet another embodiment, the wireless signal from the camera and/or other sensors attached to the anchor or anchor rode received by a first receiver on the boat may be retransmitted over a cellular, WIFI or other wireless communication interface so that the signal can be viewed from the control system on the boat or any other device (e.g., on the boat or remotely) that has a WIFI, cellular or other wireless network connection available. The type of connection may be determined and/or selected based upon a bit rate (e.g., bandwidth) requirement for the type of data and desired quality of the transmission. For example, whereas anchor location and/or movement data (e.g. moved, moved a distance of 20 meters, etc., such as that provided by sensors described in relation to another embodiment below) can be transmitted even in a very low bit rate cellular connection, a real-time video in high definition may require that a WIFI connection or at least a higher bit rate mobile connection such as a 3G or 4G connection be used.

Devices may also be provided for global positioning system (GPS) in order to coordinate monitoring and alerts, whereby a GPS device is included in, or is combined with, the anchor video monitoring system to give a position overlay with the video image. The GPS device may be attached to the anchor, anchor mount, anchor rode in close proximity to the anchor, in the camera or in the camera housing. Alerts can be generated when the GPS device (mounted on the boat or on a system component that is on the boat, above water (e.g. transmitter, reel, etc.)), or a computer in association with the GPS device, detects that location coordinates of the anchor have moved greater than a user configurable threshold (e.g. 100 foot radius from the original GPS-indicated position when the anchor was set). This would alert a user as to when to view video (real-time or stored and played back) in order to determine if the anchor is currently dragging/slipping or has already dragged/slipped from the original position.

In an embodiment where the video and GPS coordinates are connected to a wireless communication system, users may have another network (e.g., internet) connected device alerted that the GPS position has shifted in order to allow users to timely access the live video from their network connected device. This would allow alerts to network connected devices, including mobile devices such as cellular phones, to receive an alert from remote locations.

In an embodiment where the video and/or GPS coordinates are transmitted back to the boat over wired and/or wireless connection, video and/or GPS coordinates may be uploaded to a database (locally-located or accessed online at a remote location) to act as a repository and record. Video, pictures, GPS coordinates and notes may be uploaded or saved by users, or according to configured settings, for future personal or shared reference.

In some embodiments reflective markers are affixed to the anchor (e.g., small reflective strips are adhered on all parts of the anchor such as on the crown or the flukes). These reflective markers are placed so that if the anchoring is in murky water and the visibility is very poor, the boat operator can watch the camera monitor to see when the reflective markers get covered (e.g., indicating that the anchor is sinking into the sea floor). Conversely if the anchor is slipping, the operator can see the markers becoming uncovered or observe the sea floor passing over them (becoming covered and uncovered).

Camera-Attached Anchor with Data Via Cable to Buoyant Transmitter and Wireless to Receiver on Boat

An embodiment provides a camera-attached anchor with video and/or other data from the camera being provided via cable to a transmitter near or above the waterline, and then having that video and/or other data being re-transmitted wirelessly from the transmitter near or above the waterline to the boat. The embodiment includes a camera, cable reel and wireless video transmission system that may be used to monitor the anchor of the boat and/or the immediate area around the anchor. The camera may be attached to the anchor or anchor rode with a mounting system such that the anchor can be kept in sight (e.g., in the field of view of the camera) substantially all the time or as needed. A reeling system containing items, such as, the camera cable, a battery and a wireless transmitter, are encased in or mounted to a buoyant float. When the anchor is deployed from the boat, the float that contains the reeling system stays at the surface (e.g. near or above waterline) and the camera stays affixed to the anchor/anchor rode, causing the retractable cable reel to unwind as much as is needed to allow the float/reel to stay at the surface (e.g., if the anchor is 10 feet deep then approximately 10 feet of camera cable will be unreeled to allow the camera to stay with the anchor and the reel/float to stay at the surface). The transmitter that is contained in the reel/float is configured to transmit the video from the camera back to a wireless receiver (on the boat) where it can be viewed from a display monitor (active real time monitoring) of a control system. The float/reel may have at least one light on it that will allow the float/reel to be seen in low light situations (e.g. at night time). The internal battery on the buoyant float can power the camera, transmitter and onboard light. The system may also include a solar panel on board the buoyant float that will charge the battery when there is sufficient sunlight. Some embodiments may include other renewable power sources being used for charging an internal battery.

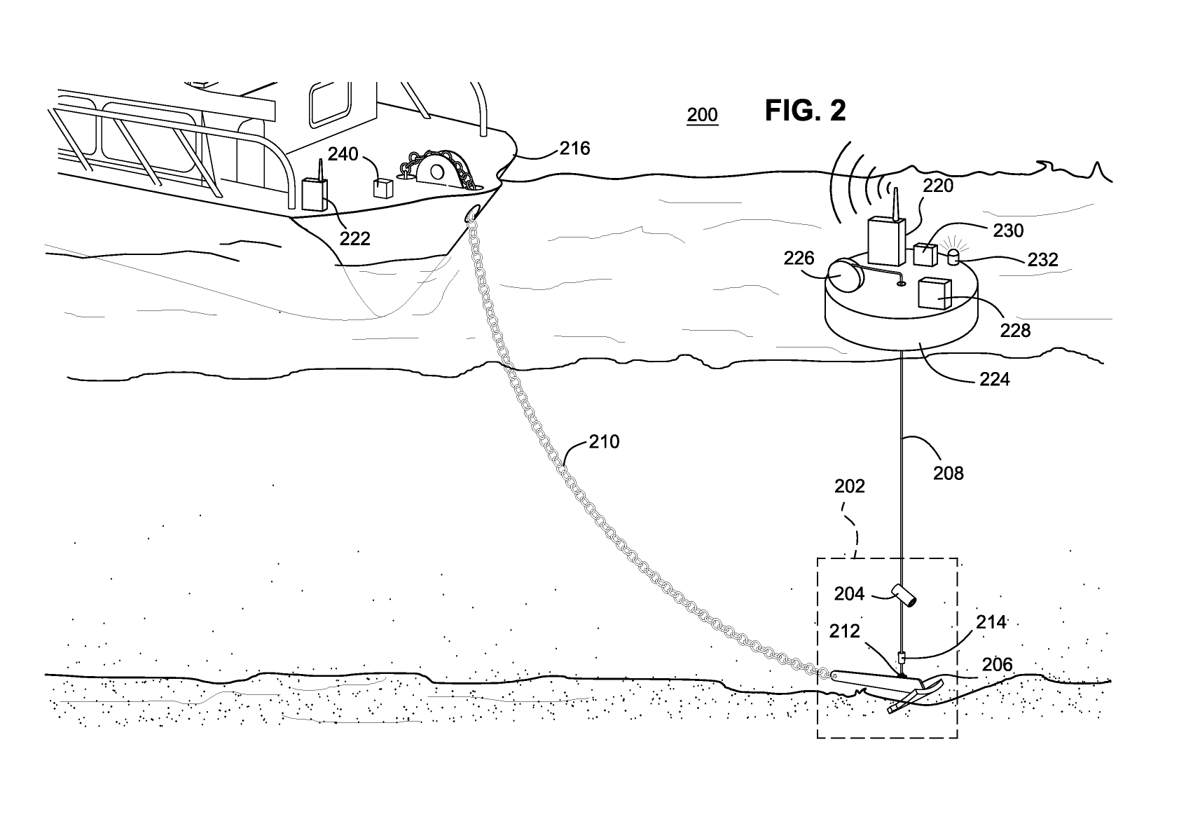

FIG. 2 illustrates an environment 200 in which a camera-equipped anchor 202 is used, according to another embodiment. A camera 204 may be attached to a location on or near the anchor 206. Camera 204 may be a waterproof camera that is, for example, capable of under water depths over 100 feet for sustained periods of time. The camera preferably includes one or more bright LEDs to illuminate an area in the field of view at night and/or other low light situations, and may include low-light sensitivity enhancement features (e.g. Sony Ex-View HAD CCD). Camera 204 may have LED's facing towards the anchor (e.g. towards the sea floor), towards the water surface, or in both directions, for clear video and illumination in low light conditions and for visibility of anchor position.

A camera cable 208 is configured to communicatively connect the camera to a wireless signal receiver/transmitter equipment 220 located on the buoyant float 224. Cable 208 may comprise a rugged cable with one or more conductors provided inside an insulated and/or armored outer jacket. The material with which cable 208 is made may include abrasion resistant materials such as, for example, Kevlar, polyurethane, polyvinylchloride and polypropylene.

Cable 208 may be connected to buoyant float 224 in one of several ways. According to one embodiment, cable 208 may run from inside the camera back into the buoyant float 224, for example, into the cable reel on buoyant float 224.

According to another embodiment, cable 208 is connected with waterproof connectors at the back of the camera 204 or within a very close distance (e.g. few inches) of the back of the camera, and the cable may be routed from the waterproof connector back into the cable reel on the buoyant float 224.

A camera cable management system may include a deployment/retraction reel 226. Deployment/retraction reel 226 provides for the camera cable 208 to be deployed and/or retracted, and may be mounted or otherwise located on the buoyant float 224. Deployment/retraction reel 226 includes a cable reel that is arranged to wind the camera cable 208 on and off the reel as the anchor 206 is deployed and/or retracted. The winding on and off cable off the reel may automatically occur also as the water depth between the anchor and the reel and/or float varies. The retraction may be based upon, for example, either spring loaded retraction, or motorized retraction, with or without a lockout feature to hold the reel from spinning. The reel may be configured to pass through power, video and audio connections via respective cables.

A camera mount 212 is attached to camera 204 at one end and to the anchor (or anchor rode 210—chain or rope) at the other end. The end connecting to the anchor (or rode) may be configured to provide for a quick disconnection (e.g., electromagnetic disconnect, magnetic disconnect, solenoid actuated disconnect, detent disconnect when a tension threshold is reached or manual release button/lever). The mount may also allow for adjustment of the camera viewing angle. In some embodiments, the camera mount may also include a security system that either locks the system to the anchor and/or transmits an alert if the system is disconnected from the anchor (e.g., to prevent theft, loss or unintentional disconnect).

A camera cable strain relief 214 includes a circumferential attachment to the outside of the camera cable to provide a point of mounting and strain relief. The strain relief housing can be mounted to the anchor, thereby attaching the cable to the anchor with strain relief and protection at the point of mounting.

Buoyant housing provides protection for the equipment in the buoyant float 224. In this embodiment, equipment including camera cable 208, camera cable reel 226, battery 228, a GPS device 230, and wireless transmitter 220 are contained in/on a protective flotation housing that provides the buoyancy for the equipment to stay at the surface of the water (e.g., deploying only the camera and substantially the required length of camera cable). According to some embodiments, camera 204 may also initially be inside the buoyant housing, and then can be deployed outside of the housing. When the camera mount 212 is connected to an anchor 206 and the anchor is deployed, camera cable 208 is configured to unwind from the reel 226 provided that the buoyant force from the housing is large enough to keep the housing and the encased system components above the surface of the water. The buoyant housing keeps the system floating over the anchor and the cable reel 226 will wind or unwind as needed to accommodate changing water depths and a range of allowable anchoring depths. The buoyant protective housing may have an indicator light 232 to provide visibility, for example, in low light environments.

Video, audio and other (e.g., GPS) signals from the floating system are transmitted where they can be received remotely (e.g. on the boat). The wireless transmitter 220 may be built into the reel 226, attached to the outside of the reel, or may be tethered to reel and mounted to another device or the buoyant housing besides the reel.

Wireless transmission from a transmitter that is connected to the camera/cable/reel and transmitting to a receiver (the transmitter is currently broadcasting to a receiver/monitor) may utilize one of several suitable frequencies and/or standards. In an embodiment, the transmission of the standard definition video signal is accomplished via 2.4 GHz, 5.8 GHz or other (e.g. 2468 Mhz, 2450 Mhz) signal. Other frequently used frequency bands and/or standards include, but are not limited to, Bluetooth 2450 MHz band, HIPERLAN 5800 MHz band, IEEE 802.11/WiFi 2450 MHz and 5800 MHz bands, and IEEE 802.15.4, ZigBee.

Wireless receiver 222 and control system 240 are located on the boat 216. The wireless signal may be received and monitored by control system 240 in one of many ways. In an embodiment, the received wireless signal may be provided to a fixed or handheld receiver that has a built in monitor (e.g. display). In another embodiment, the received wireless signal is transmitted into a receiver that can be plugged into, or is already integrated into, a monitor (e.g. separate display, computer, smartphone, or tablet). In yet another embodiment, the received wireless signal may be provided to a cellular, WIFI or other interface so that the signal can be viewed from anywhere that a WIFI, cellular or other network connection is available.

Devices for GPS position monitoring and alerts 230 may be provided, whereby a GPS device is combined with the video anchor monitoring system to give a position overlay with the video image. Alerts can be generated to show when the GPS (e.g. mounted on the boat or above the anchor in the floating housing) coordinates have moved a distance greater than a user selectable threshold (e.g., 100 foot radius from the original GPS position when the anchor was set). This would alert a boat operator or other user, who would then view the real time anchor video to determine if the anchor is dragging/slipping. In a system embodiment where the video, audio and/or GPS coordinates are connected to a cellular, WIFI or other communication system, there may be another internet or other network connected device alerted that the GPS position has shifted and allow an operator to access the live video from their internet connected device. This would allow alerts to internet connected devices such as cellular phones to receive an alert from remote locations.

In some embodiments, camera and/or sensor data may be analyzed by a microprocessor co-located or located nearby underwater with the camera and/or sensors. The processing to detect whether the anchor has moved (e.g. drifted while deployed) based upon camera image analysis and/or GPS coordinate analysis may be then performed by that microprocessor at least in part. In other embodiments, the raw camera images and/or sensor data is transmitted to equipment located either on the boat or on a buoyant float above the water line.

Camera-Equipped Anchor with Wireless Data and Control Transmission Between Camera and Boat

Another embodiment may include a camera-equipped anchor and control system on the boat, similar to the camera-equipped anchor with data cable from camera to vessel embodiments illustrated in FIG. 1 and/or the camera-equipped anchor with data via cable to buoyant transmitter and wireless to receiver on boat embodiments illustrated in FIG. 2, but where the data from the camera is transmitted wirelessly from the camera to a control system and/or to a receiver located on the boat.

In some embodiments, the video and other data (e.g., location information) may be transmitted using the same transmission technique. In another embodiment, video may be transmitted using a first transmission technique and other data may be transmitted using a second transmission technique.

The wireless transmission of video, from a transmitter mounted in proximity to the underwater camera to a receiver located, for example, on the boat, may employ one of several techniques. Some embodiments may use radio frequency (RF) electromagnetic wireless transmission. Some other embodiments may use acoustic wave wireless transmission.

Underwater radio frequency (RF) technology may have certain advantages in that, although it operates in adverse water conditions, it is unaffected by acoustic noise, is free from multi-path problems (associated with acoustic wave wireless transmission such as “sonar”) and is subject to minimal Doppler effects. RF also supports data transmission across the water/air and ground/air boundaries, penetrating the surf zone. Although mostly suited for short range transmission, RF, as used in some embodiments, allows for higher data rates (e.g., approximately 100 Kbps) than acoustic wave technologies (e.g., approximately 31 Kbps). A video stream of acceptable image quality, using codecs and compression, can be transmitted with data rates at or above 14 Kbps (e.g., although 30 kps data rate is generally more acceptable on moving targets). RF approaches make use of a transmitter/transceiver that is electrically insulated from the water and broadcast electromagnetic waves to a receiver/transceiver. Salt water, due to its electrical conductance, may highly attenuate the RF signal. Higher frequencies equal higher data rates but are more attenuated, which is why RF, in some embodiments, is limited to about 100 Kbps. The range of RF embodiments may be about 21 feet of transmission distance at 100 Kbps. Thus, because many embodiments provide for having about 100 feet between the boat and the anchor, some embodiments use one or more repeaters to jump (e.g., retransmit) the RF signal from one transceiver (e.g. repeater) to another until it reaches the receiver on the boat. According to an embodiment, the repeaters are placed along the anchor rode/chain allowing a quality signal to be passed from the anchor-attached camera RF video transceiver to a transceiver located on the boat. Transceivers would allow full duplex communication allowing wireless access and control over the system from the boat. Some embodiments may use a technology such as Seatooth® for propagating the RF signal.

As noted above, alternatively, acoustic wave wireless transmission may be used for transmitting the signal from the camera to the control system. In this embodiment, an acoustic modem system may use either, pressure sensitive hydrophones or capacitive sensitive hydrophones, as both transmitting and receiving devices (hydrophones convert a sound signal into an electrical signal since sound is a pressure wave). The hydrophones may be used in full duplex mode allowing both, the hydrophone that is attached to the anchor and the hydrophone that is attached to the boat, to be used as both transmitter and receiver (transceiver). The transceivers may include an omnidirectional beam pattern. Acoustic modems generally transmit farther distances than RF, e.g. many kilometers in some cases. In general, the shorter the distance the better the signal and faster the data rate. Acoustic modems, in some embodiments, are nearing data transmission rates of 30 Kbps which is sufficient for video transmission.

Yet other embodiments are configured to utilize the anchor rode as an RF antenna. In some embodiments, the rode or a portion of the rode is applied with a coating to improve its performance as an RF antenna. The use of the rode as an RF antenna may alleviate some of the signal propagation distance issues associated with RF transmission through water.

### Acoustic/Optical/Movement-Based Sensor-Attached Anchor

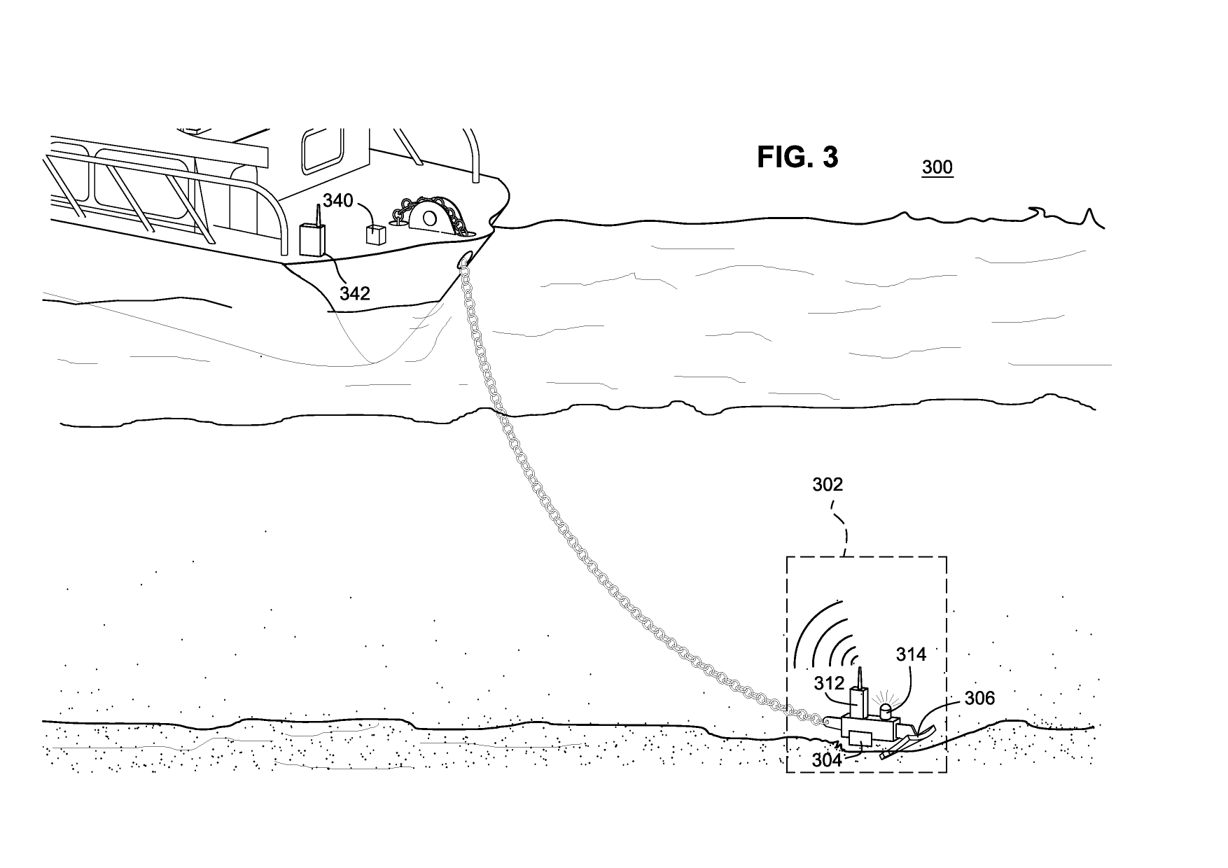

FIG. 3 illustrates an environment 300 in which a sensor-equipped anchor 302 is used in an anchor movement detection and alert system. The system is comprised of one or more sensors 304 that are mounted on an anchor or anchor rode that detects anchor movement and senses an acoustic, visual and/or electronic signal to alert that movement is detected. The system may be configured to alert a boat operator and/or control system 340 when the boat's anchor is dragging or slipping. Anchor data to be transmitted from such sensors may include, for example, moving, not moving, battery status, etc.

The one or more sensors 304 are mounted on an anchor (or on the anchor rode in close proximity to the anchor). The one or more sensors may be powered by a wired connection from the control system, or powered by an onboard (e.g. co-located with the sensors) sealed battery bank. The sensors may be coupled to an onboard microprocessor that will interpret the sensor data in order to determine if an alert should be transmitted. In another embodiment, the raw camera and/or sensor data may be received by the control system on the boat, which then interprets the received sensor data.

The one or more sensors may include any of an acoustic sensor, an optical sensor, or a physical movement sensor. An acoustic sensor may be used to detect the variation in sound when an anchor (or rode) is dragging across the sea floor. An optical sensor may be used to detect variations in the sea floor or surrounding area when an anchor (or rode) is dragging across the sea floor. A physical movement sensor may be used to detect the movement of an anchor or rode relative to the anchor floor (e.g. deflection of the sensor, pressure against the sensor, vibration of the sensor, rotation of the sensor).

Movement sensors that may be incorporated may include one or more of an accelerometer, a contact microphone or hydrophone, vibration sensor, tilt sensor, gyro or rotation sensor, “Passive Infrared”, “Pyroelectric”, or “IR motion” sensors, optical pattern recognition sensors, and ultrasound sensors.

Embodiments may include an analog or digital accelerometer. The accelerometer may be a piezoelectric accelerometer. Single and/or multi-axis accelerometers may be used for detecting force and vector of movement of the anchor. Movement exceeding a threshold vector would be used to indicate anchor movement.

A contact microphone or hydrophone, such as, ones including a piezoelectric transducer that generates electricity when subjected to a pressure change, may be used in some embodiments. The contact microphone or hydrophone may be configured to sense vibration when sensor is mounted to the anchor.

Vibration sensors that may be used in embodiments include piezo and/or MEMS vibration sensors. A vibration sensor operates to generate a voltage when a sensing area is physically deformed by a vibration, sound wave, or mechanical strain. In some embodiments, the vibration sensor is solid mounted to the anchor.

A tilt sensor operates as a device producing variable voltage output based on angular movement, for example, of the anchor. Tilt sensors that may be used in embodiments include dual axis tilt sensors, such as, for example, force balanced, solid state (MEMS) and electrolytic or capacitive (e.g. conductometric inclinometer) fluid filled sensors.

A gyro or rotation sensor operates to sense rotational motion and changes in orientation. According to an embodiment, the gyro sensor could be attached directly to the anchor to detect rotation and orientation. According to another embodiment, the gyro sensor is coupled to a separate physically rotating sensor that is in contact with the environment around the anchor (e.g. sea floor).

“Passive Infrared”, “Pyroelectric”, or “Infrared radiation (IR) motion” (“PIR” sensors) include one or more pyroelectric sensors which can detect levels of infrared radiation. Most objects emit some low level radiation, and the hotter an object is, the more radiation is emitted by it. According to an embodiment, the PIR sensor in a motion detector is split in two halves in order to detect motion (change) rather than average IR levels. The two halves are wired so that the radiation detected by one half cancel out the other half. If one half detects more or less IR radiation than the other, the output from the sensor will swing high or low. An example sensor that may be configured in an embodiment includes BISS0001 “Micro Power PIR Motion Detector IC.”

An optical pattern recognition sensor may operate, for example, by continuously analyzing images for motion. For example, using data from images obtained from a camera CCD, an average “pattern” or image can be obtained. Anchor movement can be detected based upon a magnitude of change from the average pattern.

An ultrasound sensor, such as, for example, a low frequency (e.g. 50-500 KHz range) ultrasound sensor can be used to detect anchor 306 movement based upon reflected sound waves as the area surrounding the sensor (e.g. sea floor) changes.

One or more transmitters 312 and 314 are provided for transmitting the sensor data. Sensor data transmission may be continuous or intermittent. Depending on the type of sensor included, the transmission may include acoustic transmission, visual transmission, and/or wired transmission.

Acoustic transmission provides for transmission of sensor status using acoustics such as sonar (pinging, or acoustic waves) that would emanate from the system mounted to the anchor (or rode). Data may be transmitted to a receiver 342 to show status or an alert situation. According to an embodiment, the sonar technique makes use of either, pressure sensitive hydrophones or capacitive sensitive hydrophones, to be used as both transmitting and receiving devices (hydrophones convert a sound signal into an electrical signal since sound is a pressure wave). The sonar system may be used in full duplex mode allowing both the hydrophone that is attached to the anchor and the hydrophone that is attached to the boat to be used as both transmitter and receiver (transceiver). The transceivers may include an omnidirectional beam pattern and operate, at least in some aspects in this application, as underwater modems.

Visual transmission provides for transmission of sensor status using a light (e.g., 314) that would emanate from the system mounted to the anchor (or rode). The light may either turn on or change color to indicate sensor status/alerts (e.g. whether the anchor is moving or not).

Wired transmission (for embodiments in which the sensor is wired to a control system component above water) provides for an electrical signal which is transmitted through a wire to an above water transmitter (e.g. wireless transmitter which will forward the signal) or directly into the receiver.

One or more receivers 342 are configured to receive the sensor data. A receiver unit can be mounted or contained on the boat and may receive signal through the boat's hull, require physical contact with the water (e.g. the receiver could be mounted in the boats bilge, to the underside of the boat, or hung over the side of the boat when receiving/monitoring is required) or in the instance of a wired transmission the receiver may be hard-wired to the sensor or may receive a wireless signal from the above water wireless transmitter. The receiver and transmitter can be pared so that the signal is unique and there is no interference from other nearby systems/signals. The receiver unit may receive data continuously or intermittently regarding sensor status that can be visually or audibly conveyed to a user (e.g. no movement, alert for movement or magnitude of movement). The receiver may act as a transceiver and enable 2-way communication with the underwater sensor/system (e.g. check sensor for proper function, sensor status, battery status, etc).

### Light-Equipped Anchor

According to some embodiments, a light-equipped anchor is provided. A light-equipped anchor may provide an anchor location alert system. The system may comprise one or more lights (e.g., LEDs) that are mounted on an anchor or anchor rode in order to provide the boat operator or others within proximity of the anchor/anchor rode a visual reference for the location of the anchor or anchor rode. One or more lights may be facing towards the anchor (e.g., sea floor), towards the water surface, or in both directions for visibility of anchor position.

The one or more lights may be powered by a wired connection from the control system, or powered by an onboard (e.g. co-located with the light) sealed battery bank.

In some embodiments, the lights may automatically turn-on when the anchor is deployed and the light level is low. In another embodiment, the lights may be coupled to one or more sensors and a microprocessor that will interpret the sensor data in order to determine if an alert should be transmitted. If it is determined that an alert should be generated, a predetermined light pattern may be repeatedly illuminated for a configurable time period. Preconfigured information may include a set of anchor statuses and a predetermined light pattern for each anchor status. Anchor data to be transmitted from such system through the use of light patterns, colors, or other transmission techniques may include, for example, anchor is moving, anchor is not moving, low battery status, etc. Statuses may be determined by comparing camera and/or sensor-based anchor information from an initial deployed position of the anchor with one or more later occurring positions of the anchor.

In embodiments in which the anchor has one or more attached sensors, one or more transmitters may be provided for transmitting the sensor data. Sensor data transmission may be continuous or intermittent. Depending on the type of light and sensor included, the transmission may include acoustic transmission, visual transmission, or wired transmission. In another embodiment, the raw sensor data may be received by the control system on the boat, which then interprets the received sensor data.

FIG. 4 illustrates a schematic diagram of a system 400 of the data and power distribution in a camera and/or sensor-equipped anchor, according to some embodiments. A segment 402, comprising, for example, a video supply device 412 (e.g., camera 104) may be located underwater in proximity to the deployed anchor. A segment 404, comprising, for example, a cable system 414 (e.g., cable 108 and reel 116), communicatively connects segment 402 to another segment 406. Segment 406 includes on-board components and/devices for powering the anchor attached/co-located devices and/or receiving video/audio and/or other data from the anchor attached/co-located devices. For example, a power adaptor 420 may connect the cable system 414 to a power source on the boat. A video signal on the cable system 414 may be received at a video monitor 416, and/or at a wireless video transmitter 418.

FIG. 5 illustrates a reel 500, such as, for example, the cable reel 116 shown in FIG. 1. Reel 500 may be configured to automatically extend or retract the camera cable as the water-level adjusts.

FIG. 6 illustrates a camera and cable 600 as would be used, for example, in an embodiment in which cable deployment is manual. For example, the camera and camera end of the cable may be attached to the anchor at one or more location when the anchor is deployed.

FIG. 7 illustrates a mounted camera apparatus 700. A camera 702 in a camera housing 706 is mounted on armature 716. One or more LEDs 704 may be arranged such that the field of view of the camera and, when attached to the anchor or anchor rode, the anchor and/or the area surrounding the area where the anchor is engaged in the sea floor is illuminated. In some embodiments, the number of LEDs illuminated and/or the brightness of the LEDs can be configurably controlled. The camera housing 706 may be rigidly or flexibly attached to the armature in a waterproof manner. A mounting device 714 may be attached to one end of the armature 716. The mounting device 714 may or may not include quick connect/disconnect feature with which it could connect/disconnect from the anchor or anchor rode. The camera cable 710 is connected to the camera in a manner that a waterproof connector 708 provides the cable 710 ingress into the housing 706. In some embodiments the camera cable may include separate cable portions, such as cable portion 710 and cable portion 712, that may be detacheably-connected, for example, in the mounting device 714 or other part of the camera mount 716.

FIG. 8 illustrates another mounted camera apparatus 800. A camera 802 in a housing 806 is mounted on an armature 816. As described above, one or more LEDs 804 may be arranged in relation to the camera 802. The armature 816 may be constructed such as that it can flexibly bend and return to the original shape or shape very close to the original shape after bending in response to an applied pressure, and then recovering soon after the pressure is released. In the illustrated embodiment 800, the camera cable 812 may be routed into the camera housing 806 through the armature 816. A mounting device 814 is provided in order to attach the mounted camera apparatus to an anchor or anchor rode.

FIG. 9 illustrates device 900 that can be used in embodiments to attach the camera cable to the anchor rode. Device 900 includes a pulley 904 coupled, using a coupler 908, to a carabiner 906. When device 900 is being used to couple the camera cable to the anchor rode, a wheel of the pulley 904 may freely move up and down the camera cable, such as cable 902. The carabiner 906 may be attached to a chain link in the anchor rode. The carabiner may include a spring-loaded latch. The coupler 908 couples the pulley 904 and carabiner 906 so that there is an adequate amount of flexibility so that the cable may tolerate some movement relative to the location on the rode to which it is attached. Some movement flexibility may be helpful to improve the durability of the cable.

FIG. 10 is a wireless transmitter 1000 that can be used in some embodiments, for example, to wirelessly transmit the video, audio and/or other data that much be transmitted. The transmitter 1000 can be used to transmit the signal from a buoyant housing to the boat and/or from the boat to another remote location. The transmitter 1000 a housing 1002 which houses the electronic and power source, an antenna 1004, and signal inputs 1006.

FIG. 11 illustrates a video monitoring apparatus 1100 that is used in some embodiments. The monitoring apparatus includes a housing 1102 that may have an integrated antenna or partially-integrated antenna 1106. A screen 1104 is used for viewing the video signal from the camera attached to the anchor. The screen 1104 may also display other information such as the coordinates of the camera and/or anchor location (e.g., more specifically the locationing device attached to the anchor and/or camera). Video monitoring apparatuses may include handheld DVRs, mobile devices (e.g. cellular phone, tablet, etc), computers or other devices equipped with receiving and displaying/viewing technologies.

In some embodiments, the screen may display a first set of coordinates which, for example, were recorded when the anchor is initially deployed. The screen may also display the current coordinates of the anchor, enabling a boat operator to quickly recognize if the anchor has shifted and/or dragged. The screen may also display alerts that may, for example, generated based upon anchor coordinates and/or other factors.

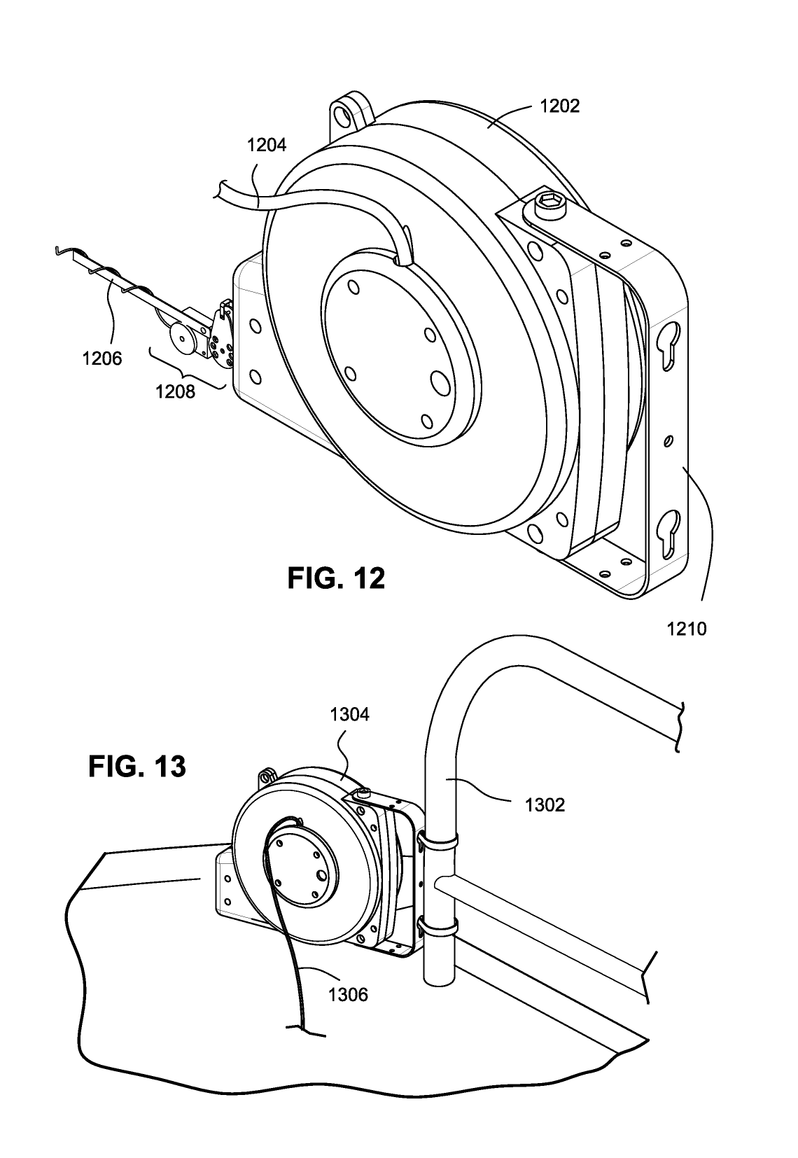

FIG. 12 illustrates a view of a cable reel 1202, according to one or more embodiments. The camera cable 1204, at one end may be connected to equipment on the boat (not shown in FIG. 12), and at the other end attached to a camera (not shown in FIG. 12). The cable coming out of the reel 1202 may be guided by a cable guide apparatus 1208 and guide path 1206 before leading off the boat and into the water. The cable guide apparatus 1208 may be configured to facilitate easier deployment and/or retraction of the cable. An attaching device 1210 may be provided for attaching the cable reel to a part of the boat.

FIG. 13 illustrates a cable reel 1304 attached to a railing 1302 of a boat. One end of the cable, coming out of the reel, may be routed (e.g. cable portion 1306) into a below deck area of the boat where the power and/or monitoring equipment is located.

FIG. 14 illustrates an alternate video transmitter 1400 which has power 1410 input (from boat) and video signal 1408 input (from camera cable) while passing through power output 1406 to another device (e.g. camera via camera cable). This transmitter allows various antennas to be attached at point 1404 with characteristics such as dB gain, signal range, signal power, etc. to be adjusted. The transmitter allows a paired connection to a monitoring device, such that the signal is private and cannot be received by unauthorized parties. System status can be monitored 1414 or reset 1412 by user. The housing 1402 may enclose the circuitry for enabling the connections. Additional interface, such as 1410 shown in FIG. 14, may be configured to communicatively couple other (e.g., a camera control and configuration device, sensor control and configuration devices) on-board equipment to anchor-attached or rode-attached devices.

FIG. 15 illustrates waterproof connector-attached camera 1500, according to some embodiments. A camera (lens of the camera is not visible in FIG. 15) is enclosed in a housing 1502. The housing 1502, may include an illuminator or light, such as an LED 1508. LED 1508 may be located such that, when the camera is deployed to monitor the anchor, the light is best positioned to be visible to the boat operator. For example, the LED 1508 may be positioned on the rear of the housing, substantially directly opposite the camera. The camera may be made of materials including a plastic, metal, or other material. The camera may include a connector portion 1506 which provides for the camera to be connected and disconnected with ease.

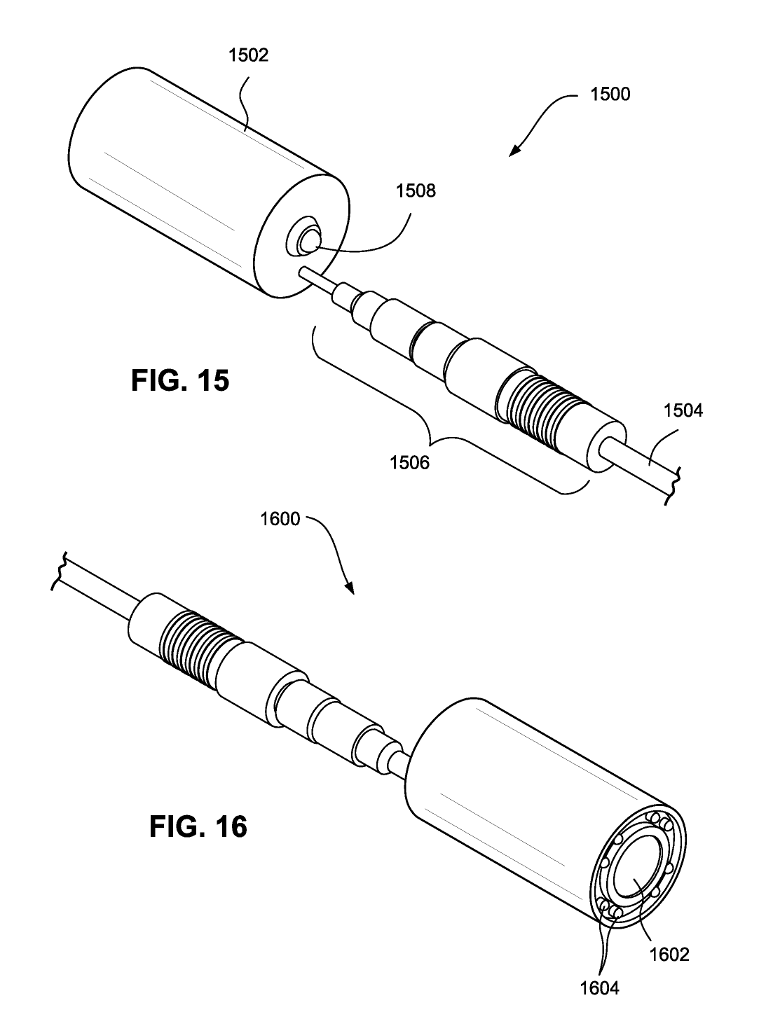

FIG. 16 illustrates another view of the camera illustrated in FIG. 15. The camera 1602 (more specifically, the camera lens 1602), and a plurality of LEDs and/or ambient light sensor 1604 may be arranged in the front of the camera housing.

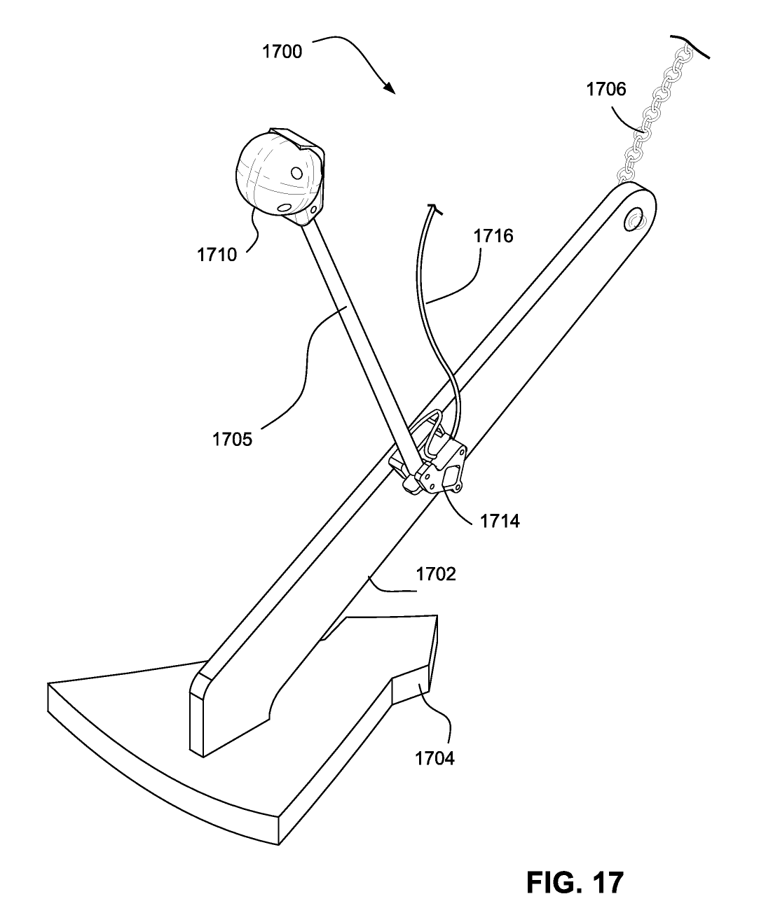

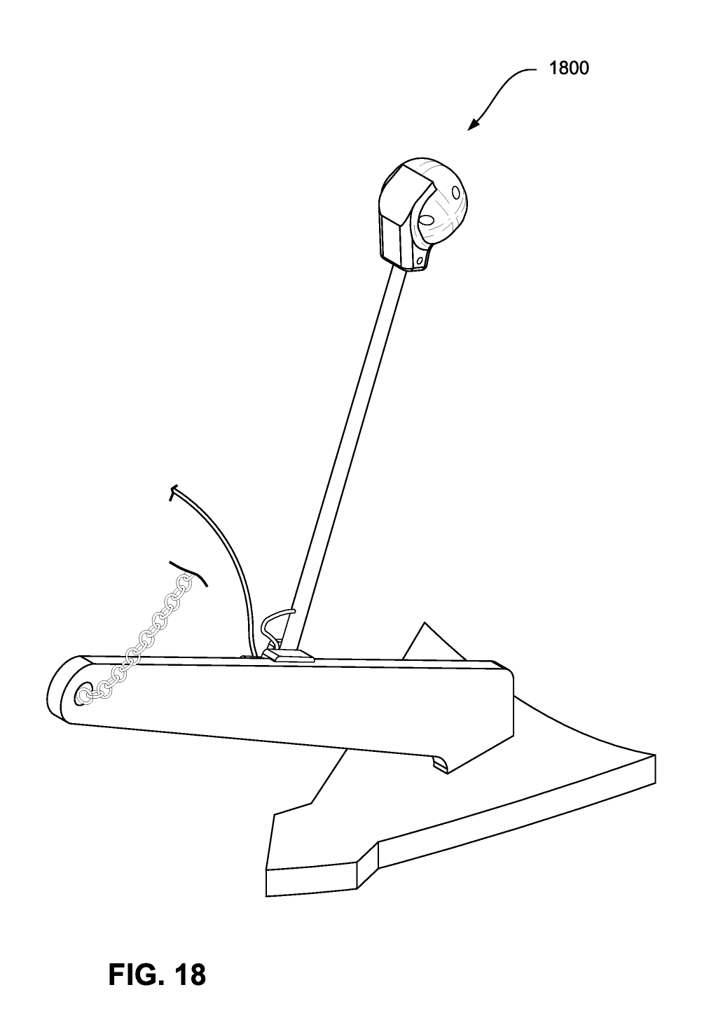

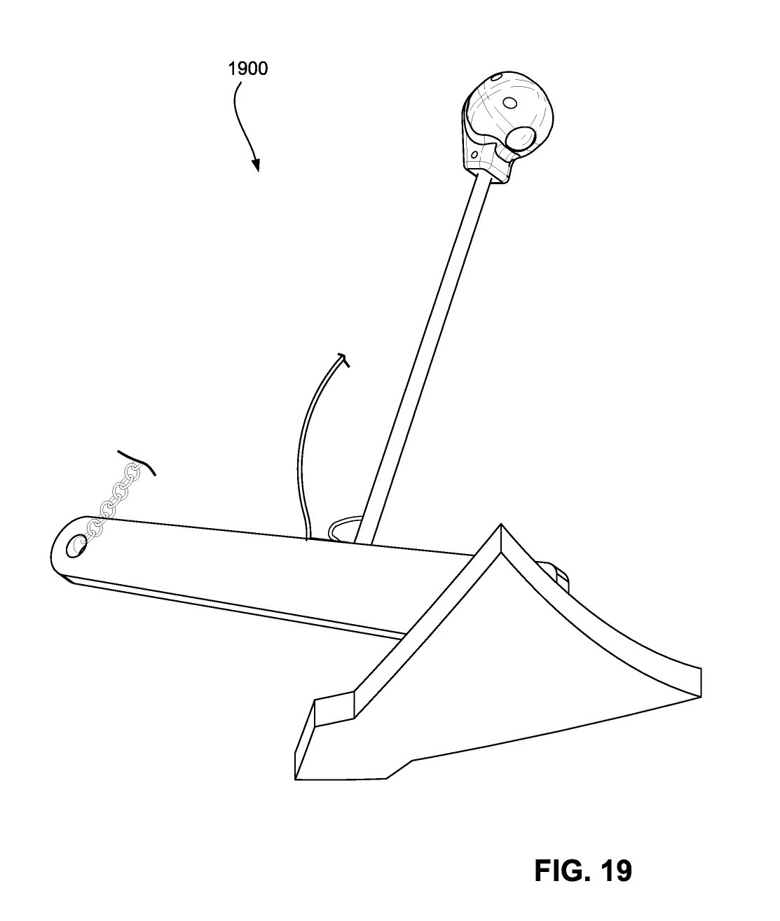

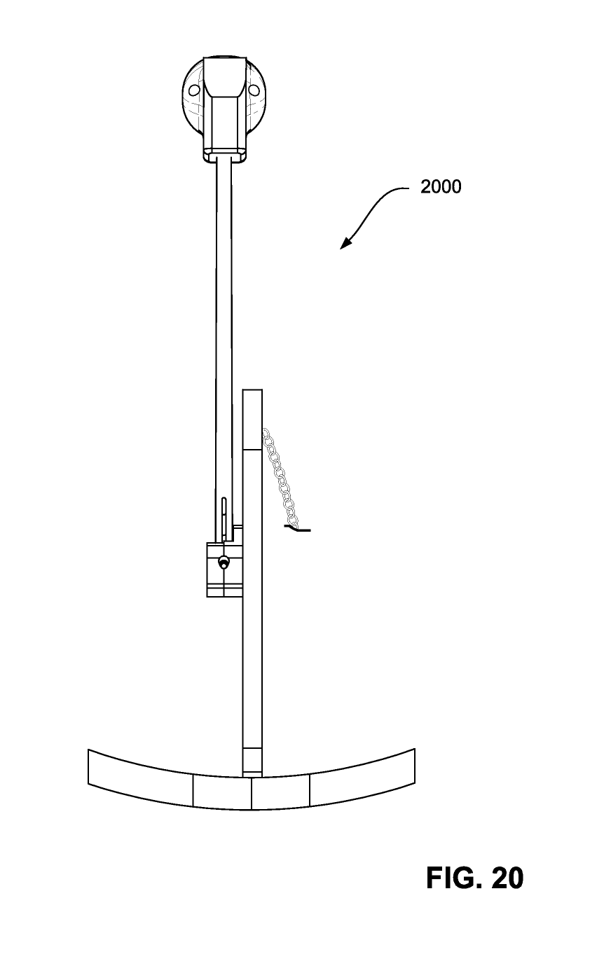

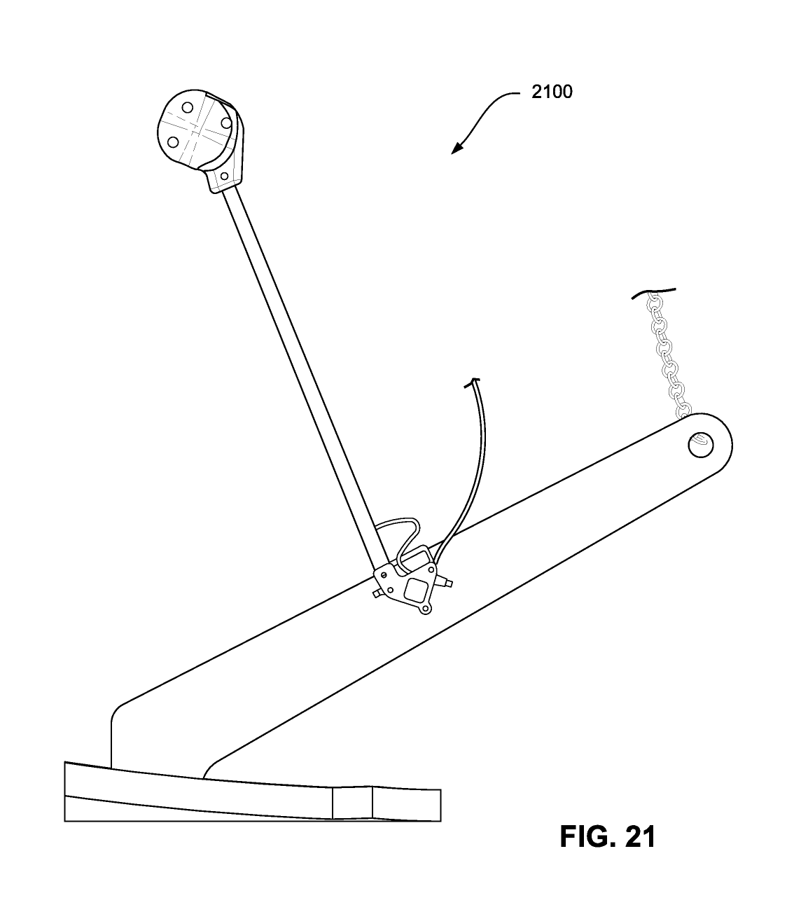

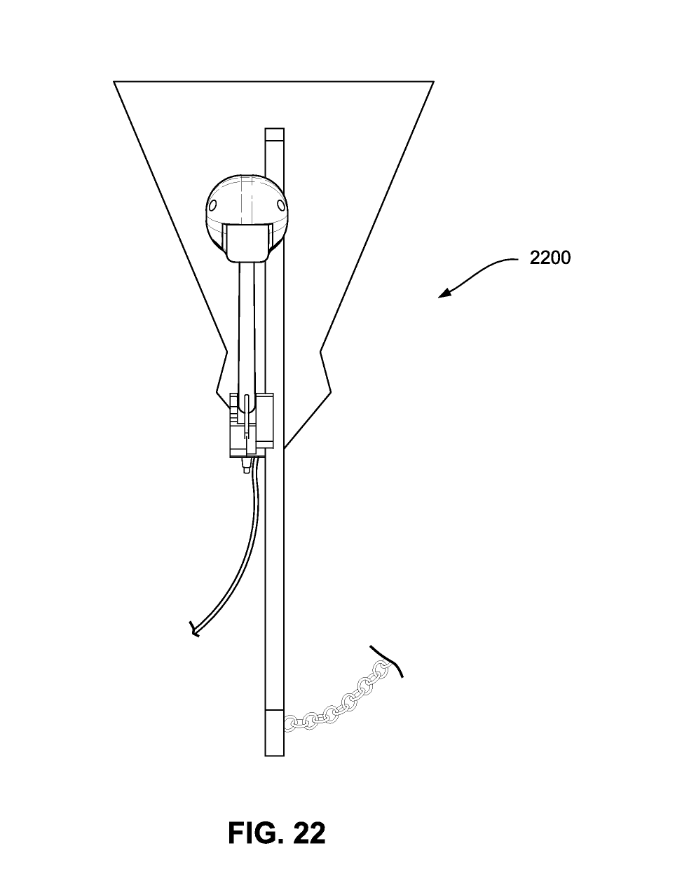

FIGS. 17-22 illustrates different views of a camera-equipped anchor, according to one or more embodiments. In the view 1700 shown in FIG. 17, a camera enclosed in a camera protective housing 1710 is attached using an armature 1705 and a mounting device 1714 to the shank 1702 of an anchor. The shank 1702 is attached to the boat by the anchor rode 1706. The camera/camera housing 1710 is connected to a camera cable 1716. The camera 1710 may be positioned so that the area of the sea floor around the fluke 1704 is in the field of view of the camera. The views 1800, 1900, 2000, 2100, and 2200 shown respectively in FIGS. 18, 19, 20, 21 and 22 illustrate various aspects of the anchor according to embodiments. FIG. 17 shows the mount overlapping the top and the side of the anchor shank. The L-shaped design provides additional rotational stability to the mount. FIG. 18 shows the protrusion in the back of the camera housing enabling the camera cable to be routed through the housing and the armature. FIG. 19 views the camera-equipped anchor from the sea floor. The camera is slightly recessed into protective housing in order to protect the camera lens and body. The mount, as illustrated in FIG. 21, contains removable screws so that the magnet and camera cable can be removed, replaced or adjusted as necessary. The mount may be designed such that the surface facing the sea floor is wedge-shaped causing a compressive force to prevent movement of the mount when setting the anchor in the sea floor (the force of the sea floor surrounding the mount causes the mount to squeeze against the anchor shank). The anchor mount includes a small handle so users have a convenient place to grab/hold during installation to or removal from the anchor.

In some embodiments, as described in relation to many of the embodiments described above, the operation of the camera, sensors and/or light attached to the anchor or anchor rode are preconfigured before the anchor is deployed. However, in some other embodiments, the camera, sensors and/or light can be controlled by a boat operator (or automated controller onboard the boat or at a remote location) after the anchor has been deployed. For example, the system may be configured to enable a boat controller to zoom-in/zoom-out, rotate the camera, enable/disable selected sensor readings, recalibrate sensor thresholds used for alert generation etc. In some embodiments, more than one camera may be deployed with the anchor. Some embodiments may include still other combinations of the camera, sensor and/or light devices described in relation to the embodiments above.

The processing required for generating alerts, analyzing the camera and/or sensor data, controlling the camera, controlling sensors, controlling lights, controlling signal transmission and receiving, displaying video etc., may be performed by computing systems onboard the boat, located in proximity to the anchor, and/or by both. The video, audio and/or sensor data may be recorded and/or stored in an electronic storage medium such as a disk, FLASH memory, or other type of memory.

Although particular embodiments have been described above, a person of skill in the art having been provided with this disclosure, would appreciate that aspects of the different embodiments may be used in various combinations to realize still other embodiments of a camera, sensor and/or light-equipped anchor.

While the embodiments presented herein have been described in detail, the foregoing description is in all aspects illustrative and not restrictive. It is understood that numerous other modifications and variations can be devised without departing from the scope of the disclosed embodiments.

1. An anchor management system, comprising:
at least one of a camera and a sensing device coupled to an anchor or anchor rode of a vessel, the at least one of a camera and a sensing device configured to enable monitoring of an area in proximity to a location of the anchor; and
one or more transmitters configured to transmit data from the monitoring to a remote receiver.

2. The anchor management system according to claim 1,
wherein the sensing device includes an acoustic sensor.

3. The anchor management system according to claim 1,
wherein the sensing device includes an optical sensor.

4. The anchor management system according to claim 1,
wherein the sensing device includes a physical movement sensor.

5. The anchor management system according to claim 1, further comprising:
a cable communicatively coupling the at least one of a camera and a sensing device to a monitoring system; and
a cable management system configured to control a deployment of the cable.

6. The anchor management system according to claim 5, wherein the cable management system automatically controls a length of the cable in accordance with the distance from the vessel to the anchor.

7. The anchor management system according to claim 5, wherein the cable management system includes one or more cable guides attaching the cable to the anchor rode.

8. The anchor management system according to claim 1, wherein the camera coupled to the anchor or the anchor rode comprises one or more light sources to illuminate a field of view of the camera.

9. The anchor management system according to claim 8, wherein the one or more light sources include light emitting diodes (LED).

10. The anchor management system according to claim 9, wherein the camera further comprises a light sensor, and wherein the LED are automatically controlled in accordance with a reading of the light sensor.

11. The anchor management system according to claim 1, wherein the anchor management system further comprises a light source configured to illuminate such that a position and/or a status of the at least one of the camera or the sensing device is visually indicated to an operator on the vessel.

12. The anchor management system according to claim 1, wherein the at least one camera or sensor device is attached to the anchor or the anchor road using a quick-release mechanism.

13. The anchor management system according to claim 1, wherein the at least one camera or sensor device is attached to the anchor or the anchor road using a bendable flexible attachment that returns to substantially the original shape after each bending.

14. The anchor management system according to claim 1, further comprising:
a protective housing attached via an extendable connector to the anchor or the anchor rode, and configured to float while the anchor is deployed;
a signal receiver located in the protective housing, and configured to receive the data from the monitoring from the at least one of a camera or a sensing device; and
a wireless signal transmission device located in the protective housing, and configured to transmit the received data to the remote receiver, wherein the remote receiver provides the data to a display in a monitoring system.

15. The anchor management system according to claim 14, wherein the extendable connector includes a cable communicatively coupling the at least one of a camera and a sensing device to one or more devices located in the protective housing, and wherein the anchor management system further comprises
a cable management system configured to control a deployment of the cable.

16. The anchor management system according to claim 14, wherein the protective housing is further configured to house the at least one of the camera and the sensing device before the anchor is deployed.

17. The anchor management system according to claim 14, wherein the protective housing further includes a power source for the at least one of a camera and a sensing device.

18. The anchor management system according to claim 1, wherein one or more reflective markers are placed on the anchor such that in the monitoring an amount of embedding of the anchor in the sea floor is determined based upon visibility of the one or more reflective markers.

19. The anchor management system according to claim 1, further comprising, based upon the monitoring, generating an alert to indicate a status of the anchor.

20. An anchor management system, comprising:
at least one light coupled to an anchor or anchor rode, and configured to enable monitoring of an area in proximity to a location of the anchor.

21. The anchor management system according to claim 20, wherein a first one of the at least one lights is configured to illuminate an area of the sea floor adjacent to the anchor and a second one of the at least one lights is configured to operate as an indicator of a status of the anchor.

22. The anchor management system according to claim 20, wherein a first one of the at least one lights is configured to operate as an indicator of a status of the anchor by transmitting a predetermined light pattern in accordance with a particular status of the anchor, wherein the status is determined based upon feedback from at least one sensing device.

23. The anchor management system according to claim 22,
wherein the sensing device includes an acoustic sensor.

24. The anchor management system according to claim 22,
wherein the sensing device includes an optical sensor.

25. The anchor management system according to claim 22,
wherein the sensing device includes a physical movement sensor.
